(19) United States
(12) Patent Application Publication
(10) Pub. No.: US 2021/0133699 A1
(43) Pub. Date: May 6, 2021

(54) COMPUTERIZED SYSTEM AND METHOD FOR USING A VIRTUAL CURRENCY

(71) Applicant: Source Ltd., Valletta (MT)

(72) Inventors: Shmuel UR, Shorashim (IL); Ilya DUBINSKY, Kefar Sava (IL)

(73) Assignee: Source Ltd., Valletta (MT)

(21) Appl. No.: 16/667,972

(22) Filed: Oct. 30, 2019

(51) Int. Cl. G06Q 20/06; G06Q 20/10; G06Q 40/04; G06Q 30/02; G06Q 20/36; G06Q 30/06; G06Q 20/40

(52) U.S. Cl. CPC G06Q 20/065; G06Q 20/10; G06Q 40/04; G06Q 20/40; G06Q 20/3678; G06Q 30/0601; G06Q 30/02

(57) ABSTRACT

A system and method for defining and using a virtual currency may include associating a fraction of a currency with at least one of: a history, an attribute, and a constraint; and selecting a usage of the fraction, in a monetary transaction, based on the at least one of: the history, the attribute and the constraint.

### FIELD OF THE INVENTION

The present invention relates generally to computer systems creating and using a virtual, digital currency. More specifically, the present invention relates to computer systems associating a fraction of a virtual and/or digital currency unit with at least one of: a history, an attribute, and a constraint and using some of the fraction, in a monetary transaction, according to the at least one of: history, attribute, and constraint.

### BACKGROUND OF THE INVENTION

Cryptocurrencies (or crypto currencies) and digital currencies are known in the art. For example, Bitcoin (□) is a digital currency (cryptocurrency or digital asset) that enables secure financial transactions, control of a creation of currency units, and verifying transfer of assets, e.g., transfer of a bitcoin or fraction thereof from one user to another. Some systems and methods of creating and managing cryptocurrencies include a distributed ledger (bookkeeping) as well as additional attributes. For example, Bitcoin uses blockchain technology for bookkeeping.

However, current systems and methods do not enable a user to associate a digitally created and managed currency or a fraction of such a currency or unit with attributes, history, rules or constraints nor do current systems and methods enable using such a currency according to attributes, history, rules or constraints assigned to, or associated with, the currency.

### SUMMARY OF THE INVENTION

An embodiment for defining and using a virtual currency may use a computing device for associating a fraction of a unit of digitally created and managed data structure representing currency with at least one of: a history, an attribute, and a constraint; and selecting a usage of the fraction, in a monetary transaction, based on the at least one of: the history, the attribute and the constraint. An embodiment may select a fraction, for a transaction, based on the transaction and based on at least one of: the history, the attribute and the constraint.

An embodiment may select whether or not to accept a fraction in a transaction based on a constraint associated with a receiving account and based on at least one of: the history, the attribute and the constraint. An embodiment may associate a fraction with a secret function; and calculate a value of the fraction based on the secret function and based the at least one of: the history, the attribute and the constraint.

An embodiment may select to exchange a first fraction in a first account with a second fraction in a second account such that first and second values in the respective first and second accounts are increased. An exchange may be performed by first and second computing devices over a direct network connection. An embodiment may modify at least one of the history, the attribute and the constraint based on a transaction, and based on at least one of: the history, the attribute and the constraint.

A history associated, by an embodiment, with a coin or fraction of a coin may include at least one of: a list of past owners of the fraction, a list of past sellers and buyers, a location, a date, a time of day, an amount, a coupon, a product purchased and a service purchased. An embodiment may associate a first history with a first fraction of a coin and a second history with a second fraction of the coin. An embodiment may associate the same history with a first and second fractions of a coin or currency.

An embodiment may associate a set of fractions of a currency with a respective set of at least one of: a history, an attribute, and a constraint; and select which of the fractions to use, in a transaction, based on relating at least one of: the a history, attribute and a constraint of the fractions to a rule or constraint or preference. An embodiment may automatically perform an exchange of currency between first and second accounts based on locations of owners of the first and second accounts.

An embodiment may determine or select whether or not to accept a fraction in a transaction based on a constraint associated with a receiving account and based on at least one of: the history, the attribute and the constraint associated with the fraction. An embodiment may associate a set of fractions of a currency with a respective set of at least one of: a history, an attribute, and a constraint; and select first and second amounts of respective first and second fractions of the currency to use in a transaction, based on relating at least one of: the a history, attribute and a constraint of the fractions to a rule or preference. Other aspects and/or advantages of the present invention are described herein.

### BRIEF DESCRIPTION OF THE DRAWINGS

Non-limiting examples of embodiments of the disclosure are described below with reference to figures attached hereto that are listed following this paragraph. Identical features that appear in more than one figure are generally labeled with a same label in all the figures in which they appear. A label labeling an icon representing a given feature of an embodiment of the disclosure in a figure may be used to reference the given feature. Dimensions of features shown in the figures are chosen for convenience and clarity of presentation and are not necessarily shown to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows a block diagram of a computing device according to illustrative embodiments of the present invention;

FIG. 2 is an overview of a system according to illustrative embodiments of the present invention; and

FIG. 3 shows a flowchart of a method according to illustrative embodiments of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items.

Unless explicitly stated, the method embodiments described herein are not constrained to a particular order in time or to a chronological sequence. Additionally, some of the described method elements can occur, or be performed, simultaneously, at the same point in time, or concurrently. Some of the described method elements may be skipped, or they may be repeated, during a sequence of operations of a method.

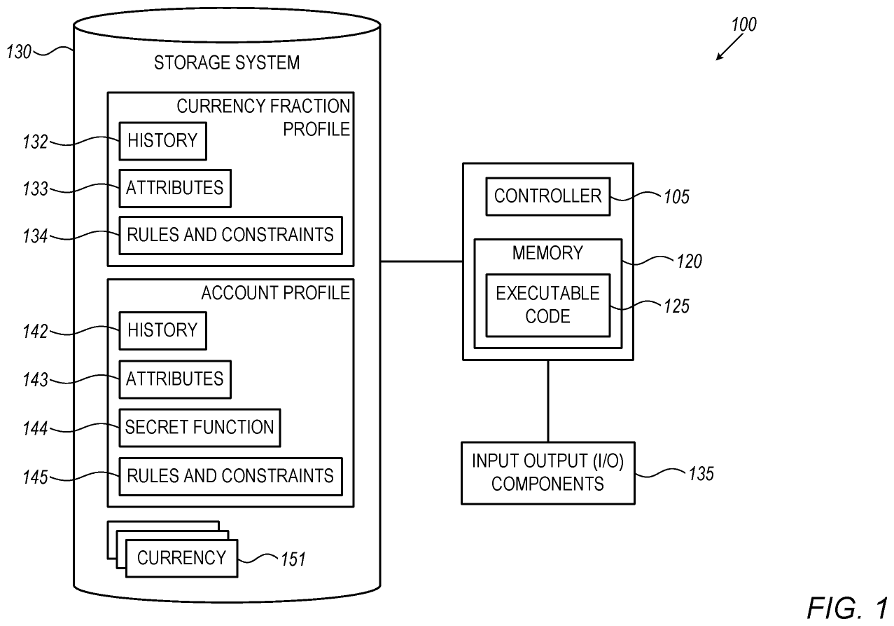

Reference is made to FIG. 1, showing a non-limiting, block diagram of a computing device or system 100 that may be used to validate monetary transactions according to some embodiments of the present invention. Computing device 100 may include a controller 105 that may a hardware controller. For example, computer hardware processor or hardware controller 105 may be, or may include, a central processing unit processor (CPU), a chip or any suitable computing or computational device. Computing system 100 may include a memory 120, executable code 125, a storage system 130 and input/output (I/O) components 135. Controller 105 (or one or more controllers or processors, possibly across multiple units or devices) may be configured (e.g., by executing software or code) to carry out methods described herein, and/or to execute or act as the various modules, units, etc., for example by executing software or by using dedicated circuitry. More than one computing devices 100 may be included in, and one or more computing devices 100 may be, or act as the components of, a system according to some embodiments of the invention.

Memory 120 may be a hardware memory. For example, memory 120 may be, or may include machine-readable media for storing software e.g., a Random-Access Memory (RAM), a read only memory (ROM), a memory chip, a Flash memory, a volatile and/or non-volatile memory or other suitable memory units or storage units. Memory 120 may be or may include a plurality of, possibly different memory units. Memory 120 may be a computer or processor non-transitory readable medium, or a computer non-transitory storage medium, e.g., a RAM. Some embodiments may include a non-transitory storage medium having stored thereon instructions which when executed cause the processor to carry out methods disclosed herein.

Executable code 125 may be an application, a program, a process, task or script. A program, application or software as referred to herein may be any type of instructions, e.g., firmware, middleware, microcode, hardware description language etc. that, when executed by one or more hardware processors or controllers 105, cause a processing system or device (e.g., system 100) to perform the various functions described herein.

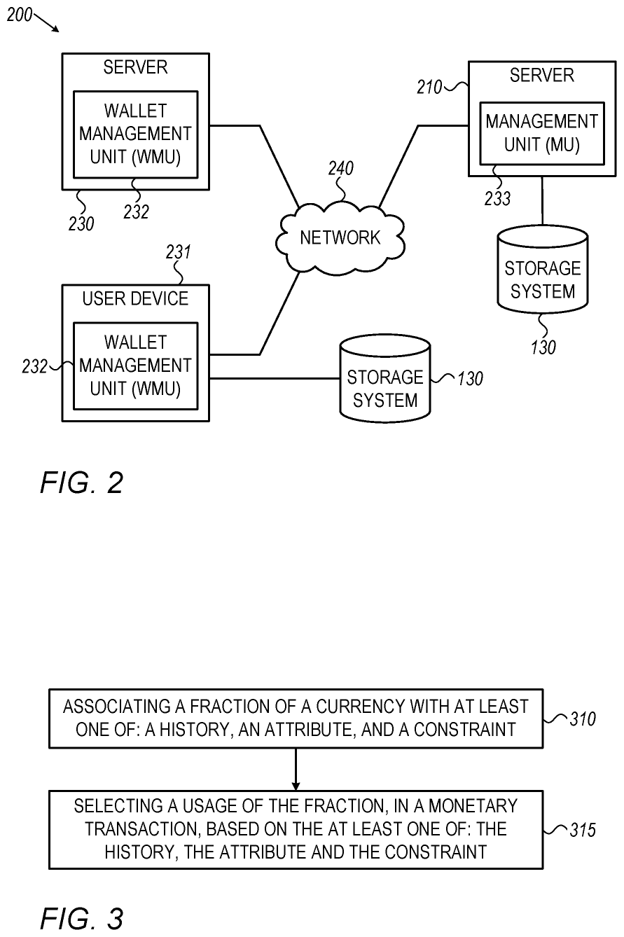

Executable code 125 may be executed by controller 105 possibly under control of an operating system. For example, executable code 125 may be an application that validates monetary transactions, or associates monetary transactions with a score as further described herein. Although, for the sake of clarity, a single item of executable code 125 is shown in FIG. 1, a system according to some embodiments of the invention may include a plurality of executable code segments similar to executable code 125 that may be loaded into memory 120 and cause controller 105 to carry out methods described herein. For example, units or modules described herein, e.g., server 210, MU 233 and user devices 230 and 231 shown in FIG. 2, may be, or may include, controller 105, memory 120 and executable code 125.

Storage system 130 may be or may include, for example, a hard disk drive, a CD-Recordable (CD-R) drive, a Blu-ray disk (BD), a universal serial bus (USB) device or other suitable removable and/or fixed storage unit. In some embodiments, for example, when included in a mobile communication device such as a smartphone or laptop computer, storage system may be a memory, e.g., a flash memory or a solid state disk (SSD).

As shown, storage system 130 may include a currency 151, a currency fraction profile 131 and an account profile 141. As further shown, currency fraction profile 131 may include a history 132, attributes 133 and rules and constraints 134. As further shown account profile 141 may include a history 142, attributes 143, secret function 144 and rules and constraints 145.

Currency 151 (collectively referred to hereinafter as currencies 151 or individually as currency 151, merely for simplicity purposes) may be any digital object that is, that represents, that includes or is used as a currency, coin or fraction of a coin, e.g., in a digital wallet. For example, a first currency 151 may be 2 digital coins associated with a first currency fraction profile 131, a second currency 151 may be a fraction of a coin, e.g., 0.5 or 0.17 of a digital coin associated with a second, different currency fraction profile 131 and so on.

Where applicable, the term “currency” as used herein may refer to currency 151. Although, for the sake of clarity, a single currency fraction profile 131 is shown in FIG. 1, it will be understood that any (possibly large) number of such objects may be included in a system, e.g., a set of currency fraction profiles 131 may be associated with a respective set of currencies 151.

Currency fraction profile 131, currency 151, account profile 141 and any of: history 132, attributes 133, rules and constraints 134, history 142, attributes 143, secret function 144 and rules and constraints 145 may be, or may be included in, any suitable digital data structure or construct or computer digital data object that enables storing, retrieving and modifying values. For example currency fraction profile 131 and account profile 141 may be, or may be included in, files, tables or lists in a database in storage system 130, and may include a number of fields that can be set or cleared, a plurality of parameters for which values can be set, a plurality of entries that may be modified and so on. For example, history 132 may be created or modified when the associated fraction of a currency unit is used, attributes 133 may be modified by an owner of the associated fraction and so on.

Data may be loaded from storage system 130 into memory 120 where it may be processed by controller 105. For example, before using a fraction of a currency 151 in or for a transaction as described, attributes 133 of the currency may be loaded into memory 120 where they may be examined by controller 105.

I/O components 135 may be, may include, or they may be used for connecting (e.g., via included ports): a mouse; a keyboard; a touch screen or pad or any suitable input device. I/O components may include one or more screens, touchscreens, displays or monitors, speakers and/or any other suitable output devices. Any applicable I/O components may be connected to computing device 100 as shown by I/O components 135, for example, a wired or wireless network interface card (NIC), a universal serial bus (USB) device or an external hard drive may be included in I/O components 135.

A system according to some embodiments of the invention may include components such as, but not limited to, a plurality of central processing units (CPU) or any other suitable multi-purpose or specific processors, controllers, microprocessors, microcontrollers, field programmable gate arrays (FPGAs), programmable logic devices (PLDs) or application-specific integrated circuits (ASIC). A system according to some embodiments of the invention may include a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a workstation, a server computer, a network device, or any other suitable computing device.

Reference is made to FIG. 2, an overview of a system 200 according to some embodiments of the present invention. As shown, a system 200 may include a server 210 that may be any suitable computing device (e.g., a network server). As further shown, server 210 may include a management unit (MU) 233.

As shown, system 200 may include a plurality of user devices 230 (collectively referred to hereinafter as devices 230 or individually as device 230, merely for simplicity purposes) and user device 231. User devices 230 and 231 may be any suitable computing device, e.g., a smartphone, a personal computer, laptop computer or any other computing device enabling a user to communicate, over network 240. As shown, user devices 230 and 231 may include a wallet management unit (WMU) 232 that may be, or may include, a controller 105, memory 120 and executable code 125. WMU 232 may be adapted to perform transactions based on one or more currency fraction profiles 131 and/or based on one or more account profiles 141. For example and as further described herein, to determine whether or not to accept, or use, a currency fraction, WMU 232 may examine a history 132 of the fraction, rules and constraints 145 of the receiving or source account, or any other parts of a relevant currency fraction profile 131 or account profile 141. WMU 232 may examine any information related to a transaction, e.g., what goods or services are purchased or sold, who the seller or buyer is and so on and WMU 232 may select whether or not to allow or perform a transaction, modify any part of a currency fraction profile 131 and so on.

MU 233 may perform any operation, logic or method described as performed by WMU 232, e.g., examine an account or currency profile, prevent or permit a transaction and so on. For example, WMU 232 units in user devices 230 may communicate with MU 233 to provide and/or receive information, thus, performing methods described herein may be jointly performed or carried out by WMU 232 units and MU 233. In some embodiments, MU 233 may maintain and manage global information, e.g., a ledger may be stored and maintained by MU 233 wherein the ledger includes information that enables verification and other operations related to currencies. For example, MU 233 may provide a first WMU 232 with information related to a currency that is known to a second WMU 232 but not yet known by the first WMU 232. Accordingly, MU 233 may provide global services for a system that includes a plurality of WMU 232 units.

Network 240 may be, may comprise or may be part of a private or public IP network, or the internet, or a combination thereof. Additionally or alternatively, network 240 may be, comprise or be part of a global system for mobile communications (GSM) network. For example, network 240 may include or comprise an IP network such as the internet, a GSM related network and any equipment for bridging or otherwise connecting such networks as known in the art. In addition, network 240 may be, may comprise or be part of an integrated services digital network (ISDN), a public switched telephone network (PSTN), a public or private data network, a local area network (LAN), a metropolitan area network (MAN), a wide area network (WAN), a wireline or wireless network, a local, regional, or global communication network, a satellite communication network, a cellular communication network, any combination of the preceding and/or any other suitable communication means. Accordingly, numerous elements of network 240 are implied but not shown, e.g., access points, base stations, communication satellites, GPS satellites, routers, telephone switches, etc. It will be recognized that embodiments of the invention are not limited by the nature of network 240.

Where applicable, computing devices, modules or units described herein, may be similar to, or may include components of, device 100 described herein. For example, user devices 230 and 231 may each include a controller 105, memory 120 and executable code 125. Accordingly, operations performed as described herein may be performed by controller 105, that is, controller 105 may be adapted or configured to perform any operation, step, logic or method described herein.

A “monetary transaction” as used herein is typically a technology operation where a data structure representing a currency is used by entity (e.g., a user or an institutional unit) operating a computer system to make a payment or incurs a liability, stated or defined in units of a currency, and another entity operating a computer system receives data and manipulates a data structure to receive a payment (or receives an asset) stated in the units of currency. The terms “monetary transaction” simply “transaction” as used herein refer to a technological event, procedure or method, not to a commerce event. For example, a transaction may be an operation or flow performed by a computerized system where the operation includes elements such as: selecting which of a set of coins or fractions to use for a transaction, determining whether or not to use or accept a currency unit, associating a personal value with a specific coin and so on. For example, a transaction may be related to a donation or gift which are unrelated to commerce.

The terms “currency”, “virtual currency”, “cryptocurrency” and “coin” as used herein may relate to any digital asset (virtual money) usable for, or in, a transaction. Similarly, a fraction of any of a coin, currency unit and/or cryptocurrency may be any digital asset usable for, or in, a transaction. For example, a coin may be used to purchase a product or the coin may be split into a hundred or a thousand fractions and some of the fractions may be used for purchasing the product. The terms “currency”, “virtual currency”, “cryptocurrency” and “coin” as used herein may relate to the same thing and may be used herein interchangeably. A fraction of a coin or currency unit as referred to herein may be any, not necessarily round, number or value, indicating whole and or partial units of a currency unit, possibly combined. For example, the smallest fraction of a US dollar is a cent and fractions of a US dollar can be 0.5 (50 cents), 0.62 (62 cents) and so on, since in some embodiments of the invention, a coin may be a digital or virtual cryptocurrency, any fraction may be used, e.g., fractions such as 0.00107 or 3.8734 may be used.

The term “digital wallet” or simply “wallet” used herein may relate to one or more digital data objects or structures that may represent, be, or may include, a set of one or more coins or coin fractions 151 owned by a user, a currency fraction profile 131 digital object and an account profile 141 object. For example, a wallet may include a set of coins 151 and a currency fraction profile 131 for each of the coins or fractions. A wallet as referred to herein may include, or may be associated with, any module or unit, e.g., a software program, that controls, implements or manages the wallet. For example, a wallet may be, or may include or may be associated with a WMU 232, a wallet account profile 141 and a plurality of fraction profiles 131. Accordingly, it will be understood that referring to a wallet may be or may include referring to one or more of: a WMU 232, a wallet account profile 141 and a plurality of fraction profiles 131.

As described, known systems and methods can associate a value with a currency but cannot associate a history, constraints or other attributes to the currency. Moreover, known systems and methods cannot associate different fractions of a currency with different constraints, attributes, rules or history. For example, Satoshi is the smallest fraction of a Bitcoin (one Bitcoin includes a hundred million Satoshi), however, known systems and methods do not enable associating a first set of constraints, attributes, rules or history with a first set of Satoshi of a Bitcoin, and associating a second, different, set of constraints, attributes, rules or history with a second, different set of Satoshi of the Bitcoin. Otherwise described, current systems and methods do not enable associating a first fraction of a currency unit (e.g., coin) with a first set of at least one of: a history, an attribute, and a constraint and associating a second fraction of the currency unit with a second set of at least one of: a history, an attribute, and a constraint.

As discussed, embodiments of the invention enable defining, treating or using a currency according to aspects such as; its history, attributes assigned by a user, user rules and so on, these capabilities cannot be realized using known or current systems and methods. For example, a physical currency (e.g. a coin) cannot be associated with a history and known systems and methods cannot associate a first fraction of a virtual or digital coin or currency with a first attribute and a associate a second fraction of the same coin with a second, different attribute. This is because, in current and known systems and methods, each coin (fraction or any other unit) is similar to every other coin or unit, (two Bitcoins in a wallet are identical) accordingly, using or treating coins or fractions of coins according to their history, attributes or constraints as described herein cannot be done with current systems and methods.

For example, some people may prefer to accept coins that were not used for any objectionable or illegal activities. Others may want coins that were not used for buying products produced from animals, e.g., meat and furs. Yet others may prefer coins that were used in charitable activities, etc. A person or institute may not want to use currency that was used in ways objectionable to them, or they may be willing to treat currency that was used for specific means in a favorable way, for example, based on a usage history and/or an attribute and/or a constraint, a user may want to associate a specific coin (or a fraction thereof) with a specific value, e.g., make coins that were used for charity worth more than coins used for gambling. While such desires or preferences of users cannot be met by known systems and methods, embodiments of the invention enable users to define and use a currency that can meet such desires or preferences of users.

In some embodiments, any system or method may be used for creating or generating a currency or coin, e.g., a computer-based mining process as known in the art may be used or a centralized or other entity may create coins or currencies. Once a currency or coin or fraction is generated, created or defined, any method of associating a history, an attribute and/or rules or constraints may be used.

In some embodiments, a computer-implemented method of defining and using a virtual currency may include associating a fraction of a currency unit with at least one of: a history, an attribute, a rule and a constraint. A method of defining and using a virtual currency may further include automatically selecting a usage of the fraction, in a monetary transaction, based on the at least one of: the history, the attribute and the constraint.

For example, WMU 232 (or MU 233) may link or associate at least one of: a history, an attribute, and a constraint with a coin or with a fragment, segment or fraction of a coin. For example, upon receiving a coin or fraction thereof from user device 231, e.g., in return for a product sold, WMU 232 in user device 230 may receive, from WMU 232 in user device 231, the history 131 of the received coin. WMU 232 in user device 230 may create a fraction profile 131 for the received coin or fraction and may record, in the history 132 of the received coin, the time the coin was received, who the coin was received from, when and where the coin was received and so on. Accordingly, a history of a coin (or any fraction thereof) may be maintained.

In some embodiments, a history (e.g., history 132) associated with a coin or a fraction of a coin (e.g., by WMU 232 or by MU 233) may be, or may include, for example, one or more smart contracts, information related to a seller, information related to a buyer, information related to a product or service bought or sold using the coin, geographical information, date and time information, information related to transactions in which the coin was involved and coupons used.

In some embodiments, a history 132 and/or attributes 133 and/or rules and constraints 134 may be associated with a coin and may remain associated with fragments, fractions or portions of the coin even when such fragments, fractions or portions are used separately. For example, pointers or lists may be used to associate a currency 151 object with a currency fraction profile 131 object. For example, a currency 151 may include a pointers or other references to a set of a history 132, attributes 133 and/or rules and constraints 134 objects, in another example, each row in a table may include, in a first entry or column, a reference to a currency 151 object and the row may include, in additional entries or columns, references to history 132, attributes 133 and/or rules and constraints 134 objects thus associating or linking the currency 151 object with the history, attributes and constraints 134 objects. For example, assume that (similar to the US dollar) a coin or currency is divisible into a hundred fractions, and further assume the coin was used to buy a lottery ticket. In such case, a history that includes a purchase of a lottery ticket may be associated with each fraction or portion of the coin. For example, if a user who owns the coin uses fifty fractions of the coin to buy ice cream then the ice cream seller will receive (and now own, or have in his wallet) fifty fractions that are associated with a history that includes a purchase of a lottery ticket. Otherwise described, a history 132 associated with a coin or with a fraction of a coin may be sticky, that is, a history 132 of a coin or fraction may include events related to the coin or fraction such that any user, person or institute receiving the coin or fraction can readily see or determine what the coin or fraction was used for in the past, who the coin was used by, where and when the coin was used and so on.

In some embodiments, recording the history of a coin or fraction may be conditional. For example, assuming a user wants to secretly own a coin, that is, she does not want the history 132 to include the fact that she owns or currently owns a coin. In some embodiments, recording an event (e.g., time of a transaction or identification of a receiver of a coin) in a history 132 may be performed based on one or more of: the currency fraction (e.g., a coin's) profile 131, an account profile 141 of the source of a coin or fraction, and an account profile 141 of the destination or receiving account.

For example, an attribute 133 or rules 134 may indicate whether or not omitting data from the history 132 is allowed or permitted, that is, whether or not a coin can be secretly transferred from one account or wallet to another. Accordingly, if a user requests to secretly transfer a coin, an embodiment (e.g., WMU 232 of the sender and/or receiver) may check attributes 133 of the coin and determine whether or not the coin can be thus transferred, if, per attributes 133 of the coin, an embodiment determines that a secret transfer is not permitted, an embodiment may block the transfer, otherwise, the transfer may be permitted and carried out. In some embodiments, the WMUs 232 on computing devices of parties to an intended or requested transaction may communicate, e.g., prior to actually performing a transaction. For example, WMU 232 on a source (e.g., buyer or payer) device may provide WMU 232 on the receiving device with a history 132 of a coin about to be transferred. Accordingly, WMU 232 may generally know everything it needs or wants to know about a currency unit that is about to be transferred and/or about the account from which the currency unit is about to be transferred, e.g., before accepting a coin, a user (or her WMU 232) can view the history 132 of the coin, attributes 133 of the coin and so on.

In some embodiments of the invention, recording the history of a coin or fraction may be selective, thus various aspects of privacy or secrecy may be enabled. For example, a transfer of a coin may be made secret by omitting (e.g. all together) the transfer from the history 132 of the coin. Accordingly, embodiments of the invention enable secret transfers of coins or fraction.

In other cases or embodiments, although a transfer itself is recorded in the history 132 of a coin or fraction, other data may be selectively omitted therefrom, e.g., the sum transferred may be recorded in the history 132 but the name or identification of the receiver or source of a transaction may be omitted, in another case, the sum and receiver may be recorded but the source of the transaction (e.g., the wallet from which a sum is transferred) may be omitted from history 132, e.g., to enable secretly donating money. Any combination of data elements related to a transaction may be selectively included in, or omitted from, a history 132 of a coin or fraction, e.g., rules 134 or attributes 133 may include parameters or values based on which a history 132 of a coin is updated, in other examples, an attribute 143 or rules 145 may indicate which data elements must be updated in a history 132 of a coin, which may be omitted, which may never be reflected in history 132 and so on. Accordingly, embodiments of the invention may automatically selectively include information in a history 132 of a coin or fraction.

In some embodiments, a “don't record history” attribute may be sticky, that is, a coin that can secretly be transferred may have no history 132 and no history can be recorded for the coin. In some embodiments, a coin for which history is and/or was recorded (e.g., had “record history” in its attributes 133) may be changed, e.g., by interacting with his WMU 232, a user may delete history 132 on user device 231 and/or on server 210 and change a coin's attributes 133 to include “don't record history”.

An account profile, e.g., in its rules and constraints 145 or attributes 143, may include an indication of whether or not the account can (or allows to) receive secret transaction and/or receive coins or fractions that do not include, in their history 132, each and every past owner, past transaction and so on. Accordingly, embodiments of the invention enable users to select, for example, using or receiving only coins or fractions whose history is fully known or visible and, in addition, embodiments of the invention enable secret transactions or ownership of currency.

In some embodiments, first and second currency fraction profiles 131 may be associated with respective first and second fractions of a single or same coin. For example, fifty fractions of a coin may be associated with a first fraction profile 131 that restricts or prevents usage of the fifty fractions for gambling, twenty fractions of the coin may be associated with a second fraction profile 131 that prevents using the twenty fractions for buying alcohol and so on.

In some embodiments, a coin or fraction profile 131, a history 132, attributes 133 and rules and constraints 134 associated with a coin remain associated with fractions, fragments or portions of a coin. For example, assuming a history, attribute and/or constraint are associated with a coin in a first user account or wallet, when a portion or fragment of the coin, e.g., fifteen fragments, are transferred to another account, the fifteen fragments (now in another account or wallet) may remain associated with the history, attribute and/or constraint of the original coin.

In some embodiments, an attribute (e.g., an attribute 133) associated with a coin or a fraction of a coin (e.g., by WMU 232 or by MU 233) may be, or may include, for example, a value or a coupon. For example, based on input from a user or owner of computing device 231, WMU 232 may associate a fraction of a coin with a discount coupon, e.g., 10% off when buying goods from a shop owned or operated by the user or owner of computing device 231. Accordingly, when the coin is used, by a user or owner of computing device 230, to buy a product at the shop, the user of computing device 230 may get a 10% discount.

In some embodiments or cases, a discount may be for a cost, possibly for a specific product, minimal sum, shop, etc. e.g., dolls are on discount in weekend days. In some embodiments, a discount may be associated with a currency, coin or fraction, e.g., an attribute 133 includes a discount value or parameter, e.g., the coin is worth 1.15 of its nominal value (effectively applying a discount) if a criterion is met, e.g., if the coin is used for buying dolls at a specific shop or website, specific date or time and so on.

Accordingly, attributes such as a discount or value of a coin may be associated with a coin, may remain associated with the coin as the coin is transferred from one user or entity to another and a transaction may be performed based on the attribute.

It will be noted that an attribute as described may remain associated with a coin (or with fractions of the coin if the coin is split into fractions as described) even if the coin changes hands, that is, is transferred between users in subsequent transactions. For example, an attribute in the form of a coupon for a specific product/shop associated with a coin may remain associated with the coin as the coin changes hands among any number of owners and then is used to receive a discount at the shop.

In some embodiments, a rule or constraint (e.g., a rule or constraint 134) associated with a coin or a fraction of a coin (e.g., by WMU 232) may be, or may include, for example, a black list of products or services that cannot be purchased by the coin, a date or time of day when the coin cannot be used, a maximal number (or value) of coins or fractions that can be used in a single transactions and so on. For example, based on input from a user of computing device 231 (e.g., a mother), WMU 232 may associate a coin with a constraint that prevents the coin from being used for purchasing alcoholic beverages and further prevents the coin from being used between 1:00 AM and 4:00 AM. Next, the coin may be transferred to the wallet of a user of computing device 230 (e.g., the son), accordingly, the son cannot use the coin for buying alcohol at a liquor store nor can the son use the coin at the specified time window. As described, history, attributes, rules and constraints associated with a coin may be, or may remain, associated with the coin or with fractions of the coin. For example, in the above mother and son example, if the son, attempting to bypass the mother's restrictions, transfers the coin (or a fraction thereof) to a friend, the friend too cannot use the coin or fraction for purchasing alcohol since the rules and constraints associated with the coin by the mother remain associated with the coin event when transferred from one account or wallet to another.

As described, a method of defining and using a virtual currency may include selecting a usage of a coin or a fraction of a coin, in a monetary transaction, based on the at least one of: the history, the attribute and the constraint. For example, selecting a usage may include selecting whether or not to use (or enable or permit usage of) a coin (or a fraction of the coin) in a specific transaction. For example, staying with the above mother and son example, if the son attempts to use the coin for buying beer at a liquor store then, prior to transferring the coin from the son's wallet to a wallet of a liquor store, WMU 232 on the son's computing device may request, from WMU 232 on the liquor store's computing device, the account profile 141 of the liquor store. WMU 232 on the son's computing device may determine, based on the received account profile 141, that the coin cannot be used to purchase goods from the liquor store (e.g., the liquor store is in a black list associated with the coin) and, accordingly, WMU 232 on the son's computing device may prevent the transaction from taking place.

Constraints and rules may be related to a product, a shop or seller, or any elements or aspect of a transaction. For example, an account profile may include a type, e.g., an account profile of a liquor store may include “alcohol” as its type, an account profile of a sporting goods website may include “sports” as its type and so on, similarly, specific products may be associated, e.g., by a shop owner, with types. As described, a WMU 232 may examine the type of a seller or shop prior to enabling a transaction.

In another example, a WMU 232 may examine the amount in a transaction, thus, for example, a restriction on the amount spent in a single transaction may be imposed, e.g., a parent may prevent a child from spending more than a predefined sum by associating a set of coins with a restriction on the total sum in a single transaction.

In some embodiments, a fraction of a currency unit may be selected based on an intended transaction, based on a product about to be purchased, and further based on at least one of: a history, an attribute and a constraint associated with the fraction. For example, a user may have, in his wallet, two different currencies, both of which can be used for purchasing a product. The user may further include, e.g., in her account profile, a preference. For example, a preference may be “prefer to avoid currency that was historically used for buying meat” or a preference may be “prefer to use money received from David” and so on. Generally, a preference may be any condition related to a history or attribute of a currency, and, since the history and attributes of a currency are known to WMU 232, WMU 232 may automatically select which of the (possibly many different currencies) in a wallet to use for a transaction.

In another example, a coin or fraction may be associated with a discount at a specific store, e.g., the currency was associated with a coupon and then transferred, from the store to one of its suppliers. Assuming a user has a currency associated with a discount coupon for a specific store, when the user initiates a purchase at the store, WMU 232 on the user device may identify the store (e.g., based on the account profile 141 of the store as described) and may automatically select to use the coin associated with the discount coupon for the store.

In some embodiments, WMU 232 may select whether or not to accept a currency or a fraction, in a transaction, based on a constraint associated with a receiving account and based on at least one of: the history, the attribute and the constraint.

For example, rules and constraints 145 may exclude electronic money (e.g. electronic currency) that was used, sometime in the past, to purchase meat or non-kosher food, in such case, if WMU 232 on the receiving device (e.g., device of a seller) identifies, e.g., based on a history 132 received from a source (e.g., buyer) device that a currency or fraction of a currency unit has been used, in the past, for buying or selling meat or non-kosher food then WMU 232 on the receiving device may prevent the transaction. Of course, if a transaction is prevented as described then a message may be displayed to users (e.g., both seller and buyer), for example, a message presented on screens of user devices 230 may inform that a transaction has been prevented because the currency about to be used violates a rule or criterion of the receiver. Any rule or constraint 145 or 134 may be used for preventing or disabling a transaction, e.g., a user may refuse to accept a currency that was used in a specific locale, a specific day of week, a time window and so on. Accordingly, WMU 232 may prevent reception of a currency based on past or historical owners of the currency, products or services bought or sold using the currency and so.

For example, a rule of constraint 145 may indicate that user refuses to accept currency that used on the Sabbath, accordingly, prior to accepting a coin, WMU 232 on the user's device may check the history 132 of the coin about to be transferred and refuse to accept the coin if it was ever used on Sabbath. In another case, a user may set an attribute 133 of a coin that prevents the coin from being used on Sabbath thus effectively creating a kosher coin. In some embodiments, WMU 232 units of parties in a suggested or intended transaction may communicate prior to an actual transfer of currency, e.g., WMU 232 units in a buyer's and seller's devices may provide each other with any information in their respective account profile 141 and currency profiles 131, accordingly, a receiving WMU 232 may be provided with or know, in advance, a history 132 of a coin, attributes 133 of the coin, constraints 145 and may use such information in order to decide whether or not to accept a currency, what value to associate with a received currency and so on.

Some embodiments may associate a coin, currency or fraction of a currency unit with a secret function 144 (and/or secret personal values of currencies, coins or fractions) and calculate a value of the coin, currency or fraction based on the secret function 144 and based the at least one of: a transaction, and a history, an attribute and/or constraint related to the coin, currency or fraction. Some embodiments of the invention enable a user to associate different, personal values to respective different currencies and to further perform a purchase (or transaction) such that the amount transferred or paid is minimized with respect to the personal value. For example, assuming a user has, in his wallet, 10 coins and further assume that, as indicated in their respective currency profiles, five of the coins are worth more to the user than the other five (e.g., they were received from a famous person, they were never used for buying weapon). Denoting the coins worth more to the user H coins and the ones worth less L coins, if the user wants to buy a product that costs six coins then WMU 232 may automatically select to transact to the seller five L coins and one H coin thus minimizing the personal cost to the user. Accordingly, embodiments may automatically select coins (or fractions of coins) for a transaction or purchase according to user preference or personal value.

In a more complicated scenario or example, assuming a user has lots of different currency fractions, each associated with its own history, constraints, rules and attributes. The user can, e.g., by interacting with WMU 232, create an evaluation function (e.g., secret function 144) for her wallet. For example, secret function 144 may associate, with each currency or fraction, a value multiplier. For example, secret function 144 may add 10% to the value of currencies or fractions previously owned by a celebrity (e.g., a specific pop star or Instagram entity), add 10% to the value of currencies or fractions that were owned by users in more than forty countries, reduce the value of currencies or fractions that were used to buy fur or meat by 15%, reduce the value of currencies or fractions that were used to buy weapon by 50% and so on. For example, such value rules may be included in rules 134.

Assuming a user has five different currencies or fractions types denoted as A, B, C, D and E. Further assuming the amounts of currencies or fractions in the user's wallet are: 74 A, 23 B, 0.6 C, 0.5 D and 0.22 E, in such case, WMU 232 may calculate the total value in the user's wallet by adding or subtracting a value to/from each currency, e.g., by: 0.74 A+35%, 23 B+28%, 0.6 C+2%, 0.5 D (no change) and 0.22 E−15%. For example, a rule 145 may indicate that currency of type A is one of high value (+35%) and, accordingly, WMU 232 adds 35% to its nominal value in the above example. WMU 232 may calculate a personal, secret, total value or sum in a wallet based on the added or subtracted values. Of course, other account rules or restrictions may be taken into account, e.g., currency of type C cannot be used for buying alcoholic beverages before Aug. 18, 19.

Staying with the above example, assume the user wants to buy a bottle of vodka from a merchant, and further assume the bottle of vodka costs 1.1 coins. WMU 232 on the user's device may provide WMU 232 on the merchant device with the list and amounts of currencies A, B, D and E. Note that based on the rule or constraint that forbids using currency C for purchasing alcoholic beverages, WMU 232 on the user's device excludes currency C from the list provided to the merchant side. In some embodiments, the list provided includes an amount of each currency but does not include (or disclose) the values calculated based on the user's preferences, e.g., WMU 232 on the merchant device is provided with 0.74 A (nominal amount of currency A) but not with 0.74 A+35% (user's secret value).

In some embodiments, WMU 232 on the merchant (seller) device may examine the merchant's secret values of the currencies in the list, for example, assume these are: A (no change), B+12%, D (no change) and E (no change). As can be seen, currency B is worth more to the merchant than other currencies, accordingly, WMU 232 on the merchant may prefer to receive currency B. In addition, note that in the current example, WMU 232 on the user's device prefers to use currency E which, to the user (buyer) is worth less than the other currencies.

Either WMU 232 on the merchant (seller) device, WMU 232 on the user (buyer) device or MU 233 on server 210 (which may be provided with the lists from the two WMU 232) may calculate a relative value difference, e.g., 0.74 A−35%, 23 B−16%, 0.5 D and 0.22 E+15.

Accordingly, MU 233 on server 210 or WMU 232 on the user (buyer) device may prefer to first use the 0.22 of currency E (which is worth less to the buyer than to the seller), next an embodiment may select the 0.5 of currency D thus totaling 0.72 and still missing 0.38. Since to the seller, currency B is worth its nominal value +12%, to complete the price of 1.1 by adding 0.38, WMU 232 on the user (buyer) device may add 0.38/1.12 which is 0.34 B (not 0.38 B). After the transaction has taken place, the user's wallet may include 0.74 A+35%, 22.661 B+28% and 0.6 C+2%.

In some embodiments, WMUs 232 on first and second users devices (or MU 233 on server 210) may select to exchange a first fraction in a first account with a second fraction in a second account such that at least one of first and second values in the respective first and second accounts are increased. For example, assuming the user or owner of computing device 231 prefers coins that were never used to buy furs, e.g., the personal value of such coins in the user's account profile (currency profile) is +10%, and further assuming that the user or owner of computing device 230 is indifferent as to whether or not coins were used for trading furs then the WMUs 232 on computing devices 230 and 231 may automatically exchange one or more coins in the first account with respective one or coins in the second account. Of course, in some cases coins a first user dislikes (and prefers to get rid of) and which a second user likes or wants may be automatically exchanged for coins which the second user dislikes (and prefers to get rid of) and which the first user wants or likes. Accordingly, embodiments of the invention may automatically exchange or transfer coins or fractions between first and second users to the benefit of both first and second users.

In some embodiments, each wallet (or account) has or includes, for each fraction or coin, a factor indicating how much the coin or fraction is worth to the account or electronic wallet's owner. It may be the case that a trade between first and second wallets or accounts is beneficial to both respective owners.

For example, assuming a first wallet includes 23 fractions of coin type A, evaluated internally at 1.3 as described, 5 fractions of type B, evaluated internally at 0.8, 0 fractions of type C, evaluated internally at 1.2 and 0 of fractions of type D, evaluated internally at 1. Accordingly, the total value of the first wallet is 23*1.3+5*0.8=33.9. Further assume a second wallet or account includes 0 fractions of type A, evaluated internally at 1, 0 fractions of type B, evaluated internally at 1, 15 fractions of type C, evaluated internally at 1 and 40 fractions of type D, evaluated internally at 0.9. Accordingly, the total value in the second wallet is 15*1.2+40*0.9=54.

If five coins of type B are transferred from the first account to the second account in return, or exchange, for five coins of type D transferred from the second account to the first account then both first and second owners of the respective first and second accounts or wallets benefit from the exchange. Accordingly, an embodiment, e.g., MU 233 or WMUs 232 that may perform the above exemplary calculations and exchange, may transfer or exchange coins or fractions between first and second accounts or users to the benefit of all parties.

In some embodiments, e.g., via or using MU 233, users can offer coins for exchange and/or users can place bids for coins. For example, a user can offer coins for sale indicating a price for the coins, inform coins s/he wants to buy at an indicated price and so on. For example, a user may publish a desired and suggested price for a coin previously owned by a specific person or institute, a user may suggest to sell or buy a coin that was used to sell or buy a specific product or service and so on. In some embodiments MU 233 may function or operate as an exchange entity enabling users to place bids for coins, offer coins for sale and so on and, according to indicated preferences, rules and thresholds, MU 233 may automatically preform exchanges of currencies between accounts.

For example, assuming a first wallet or account includes 10 coins of type X, each worth, to the account owner, 1.1 and 10 coins of type Y, each worth, to the account owner, 1 thus the total value in the first wallet is 21. Further assume a second wallet or account includes 20 coins of type X, each worth, to the account owner, 1 and 20 coins of type Y, each worth, to the account owner, 1, thus the total value in the second wallet is 40. In such case MU 233, or WMUs 232 on the respective computing devices, may determine that, if five coins of type X are transferred from the second wallet to the first wallet in exchange for five coins of type Y transferred from the first wallet to the second wallet then the total value in the second wallet remains unchanged but the total value in the first wallet is increased, accordingly, MU 233 or the WMUs 232 on the respective computing devices may suggest a transaction or exchange as described and, given a consent is received from owners of the accounts or wallets, an exchange as described may be carried out.

In some embodiments, an exchange or transaction as described may be performed without disclosing the secret function or associated personal values of currencies. Any logic may be used such that two parties to a transaction or exchange benefit from the exchange. For example, the gain or increased value resulting from an exchange as describe may be split between parties, e.g., by automatically transferring coins or fractions from one wallet to another.

In some embodiments, an exchange of coins between first and second accounts may be performed, by first and second computing devices, over a direct network connection. For example, a peer to peer (P2P) or even a direct physical (wired) connection between computing devices 231 and 230 may be used for exchanging coins such that no third party or network node is involved in the transaction.

In some embodiments, a transaction or exchange may be initiated based on locations of owners of accounts, wallets or computing devices. For example, WMUs 232 in computing devices 230 and 231 may communicate, determine or identify that computing devices 230 and 231 are in close proximity to one another and use a secured, direct communication channel to perform an exchange of coins as described. For example, a Bluetooth or WiFi network may be used by WMUs 232 in computing devices 230 and 231 to exchange coins or fragments as described.

In some embodiments, modifying at least one of a history, an attribute and/or a constraint, either in an account profile 141or in a currency fraction profile 131 may be based on a transaction, and based on at least one of: the history, the attribute and the constraint of the account profile 141 and/or the currency fraction profile 131. For example, a history 131 of a currency may be updated, based on a transaction, such that it includes the transaction. In another case, a secret value of a coin may be changed such that it reflects the product purchased in the transaction. Of course, a user may, e.g., by interacting with WMU 232, change or remove an attribute 131 of a coin, add a rule or constraint 134 to a coin or fraction, modify a secret function 144 or a rule 145 and so on.

In some embodiments, a history 132 of a currency unit or fraction includes at least one of: a list of past owners of the fraction, a list of past sellers (e.g., entities, people or shops that received the currency unit in return for a product) and buyers (e.g., entities, people or shops that used the currency unit to buy a service or product), a location, a date, a time of day, an amount, a coupon, a product purchased and a service purchased. For example, one or more data elements that identify an owner of a currency, e.g., name, home address, business address, phone number and the like may be automatically included in a history 132 of a currency each time the currency (or fraction) is used, transferred from one account to another or changes hands. Similarly, data elements as described identifying a buyer and/or seller related to a transaction in which a currency or fraction are used may be added to history 132 whenever the currency or fraction is used or changes hands. As described, including or recording events in a history 132 may be conditional, e.g., it may be performed based on an attribute 133 of a coin.

A history 132 of a currency or fraction may include a location, a date, a time of day, an amount, a coupon, a product purchased, a service purchased. For example, when a currency is used, the locations of the seller and buyer may be recorded in history 134 of the currency, the time and date when the currency was used may be recorded, the amount or number of coins may be recorded in history 134 of the currency, and so on. A product or service purchased using a coin or fraction may be recorded in history 134 of the coin or fraction as are the amount used in transaction. Usage of a coupon may be recorded in history 134 thus, when receiving a coin, a user may readily know what the coin was used for in the past, when and where the coin was used, what coupons where used with the coin and so on.

In some embodiments, a history 134 and/or an attribute 133 and/or rules and constraints 134 of a coin may be associated with at least two fragments of the coin if or when the coin is split or divided into fractions or segments. For example, if a history 134 of a coin received by a user indicates, or includes, the fact that the coin was historically owned by John Doe then, if, by transferring a fraction of the coin to the wallet of the owner of an ice cream parlor, the user subsequently uses a fraction of the coin to buy ice cream, the history 134 of the fraction (now in the wallet of the ice cream parlor owner) may indicate, or include, the fact that the fraction was historically owned by John Doe, and, at the same time, the (remaining) fraction of the coin in the user's wallet may also indicate, or include, the fact that the fraction was historically owned by John Doe. Similarly, an attribute 133 of a coin or fraction may remain associated with fractions of the coin or fraction even if the coin or fraction is split into fractions or sub-fractions, transferred from one wallet or account to another or changes hands. Otherwise described, a history 134 and/or attribute133 of a coin or fraction may be sticky, that is, the history and attributes may be, or may remain, associated with fractions of a coin as the coin as divided into fractions or segments that may be transferred to different accounts or wallets. In some embodiments, a history 134 may be kept or maintained using the blockchain technique or a blockchain system such that a history of a coin (and fragments or fractions) cannot be changed.

As described, combined with rules and restrictions (e.g., rules and constraints 145), a history 134 of a coin enables users to select to use coins based on their history, object to receive coins based on their history and so on. For example, in some embodiments, a set of fractions of a currency may be associated with a respective set of at least one of: a history 134, an attribute 1343, and a constraint 134; and an embodiment may automatically select which of the fractions to use, in or for a transaction, based on applying a constraint, rule or criterion (e.g., a rule or constraint 134 or 145) to at least one of: a history 134, an attribute 133 and a constraint 134 of the fractions. For example, if a user prefers not to own currency used in France then a rule 145 in the user's account may include “always use coins or fractions used in France” and, accordingly, to pay for a product, WMU 232 may examine the history 134 of coins the user's wallet, find coins or fractions used in France and use those coins first, thus, based on applying the rule related to currency used in France to the history of currencies in the user's wallet, currencies are selected.

In another example, a user may not want to receive coins previously used for buying meat, accordingly, a rule that prevents receiving coins that were used for buying meat may be applied to a history 132 and/or to attributes 133 of a coin about to be received. To check or determine whether or not a coin about to be received was ever used for buying or selling meat, WMU 232 may apply or match the rule related to meat described above (e.g., check each past owner a coin and check whether or not it is a seller who sells meat, check the list of products bought and/or sold using the coin) and, if it is determined (e.g., based on a previous owner of the coin which is a shop that sells meat) that the coin was used for buying or selling meat, WMU 232 may refuse to receive the coin. As described, in some embodiments a WMU 232 on an intended receiving device or wallet may know or possess, in advance and before receiving a coin, any one of the history 132, the attributes 133 and rules and constraints 134 of the coin about to be received. For example, a receiving WMU 232 may receive, from a sending WMU 232 any information related to a coin about to be transferred, accordingly, embodiments of the invention enable full control of currency received be a user or wallet, e.g., the control may be realized by WMU 232 applying or matching rules and constraints 145 to a history 132, attributes 133 and rules 134 of a coin that is to be transferred to a wallet managed by the WMU 232.

Of course, far more complicated rules or functions for selecting which coins or fractions to use are possible. For example, rules involving past owners of a fraction, past sellers and buyers, location, date, time of day, coupons, products or services, location may be configured or set by a user and WMU 232 or MU 233 may select coins or fractions based on such rules.

As described, an automatically selected usage of a coin or fraction may include selecting how many fractions of each of a set of coins to use in a transaction or purchase, e.g., WMU 232 may select to complete the sum for a purchase using three coins having a first attribute 133 and two coins having a second attribute.

For example, a user may want to a fraction of a specific coin, e.g., the fraction has (or includes or is associated with) a coupon or discount, or it is a collectors' item or is associated with a criterion (e.g., usable to enter a specific party or event) and so on. As described, any such attributes may be associated, by embodiments of the invention, with a currency. For example, by setting an attribute 133 of a coin (e.g., mark as favorite) and by further setting rules 145 such that some (e.g., favorite) coins are used last or are kept above a minimal level in a wallet, the user can cause WMU 232 to automatically select other coins for buying a product. Automatically selecting coins or fractions for a transaction may be based on any data element in any one of account profiles 141 of the parties to a transaction and/or currency profiles 131 of a set of currencies or fractions in a wallet.

In some embodiments, an automatically selected usage may include selecting whether or not to accept a coin or fraction in a transaction based on a constraint associated with a receiving account, e.g., WMU 232 may refuse to receive a coin based on the coin's history 134 or based on an attribute 133 of the coin. Accordingly, embodiments of the invention may select a usage of a coin based on any one of a history 134, attribute 133 and/or constraint 134 of the coin or fraction. Embodiments of the invention may select a usage of a coin by automatically selecting whether or not to accept a coin or fraction of a coin based on an attribute 143, secret function 144 and/or rules or constraints 145 of a receiving account. For example, a rule 145 in an account may indicate that coins used in Italy or coins used before 1994 are not be accepted, accordingly, WMU 232 may refuse to accept a coin if its history includes usage of the coin in Italy or usage prior to 1994.

Reference is made to FIG. 3, a flowchart of a method according to illustrative embodiments of the present invention. As shown by block 310, a fraction of a coin or currency unit may be associated with at least one of a history, an attribute and a constraint. For example, WMU 232 may associate a coin or a fraction of a currency unit with an attribute (e.g., associate a coin with a value), a rule (e.g., don't use before Aug. 24, 19) and a history, e.g., history 132 as described herein.

As shown by block 315, a usage of a coin, currency or fraction thereof, in or for a transaction (e.g., pay for a product, receive payment for a service etc.) may be selected based on at least one of: a history, an attribute and a constraint or rule associated with the coin, currency or fraction. For example, WMU 232 may automatically select to use, for purchasing a product, a first coin and not a second coin, e.g., based on user preferences, based on the histories of the coins, based on coins the seller is willing to accept and so on.

Known or current computerized systems and methods enable creating or modifying data structures representing currencies or coins (e.g., mining Bitcoins), transactions and bookkeeping (e.g., using blockchain records). However, to name a few drawbacks current or known systems and methods suffer from, a coin or currency has a known value for all users, a first coin in a wallet cannot be associated with a history that is different from the history of another coin, and different attributes cannot be associated with different coins in a wallet of a user.

Embodiments of the invention improve prior art technologies related to cryptocurrencies. Embodiments of the invention enable computerized systems and methods to define, treat and/or use a cryptocurrency according to a host of aspects, e.g., a history of a coin, attributes associated with a coin, personal value and more. For example, and as described herein, embodiments of the invention enable associating a coin (e.g., a crypto coin) with a history 132, and further selecting whether or not to use the coin, in a specific transaction, based on its history. In another example, embodiments of the invention enable associating a personal value with some of the digital coins in a digital wallet, in yet another example, embodiments of the invention enable an automated method of selecting which of the coins in a wallet to use for a transaction.

A cryptocurrency and its associated history 132, attributes 133 and rules 134, as well as an account's attributes 134 and rules 145, as described herein, provide a computerized system and/or method that is far superior to current or known systems and methods. Embodiments of the invention may provide a new and novel digital entity in the form of a digital cryptocurrency that has, or is associated with, a history, attributes and rules, embodiments of the invention further provide a new and novel system and method for using the new and novel digital cryptocurrency.

In the description and claims of the present application, each of the verbs, “comprise” “include” and “have”, and conjugates thereof, are used to indicate that the object or objects of the verb are not necessarily a complete listing of components, elements or parts of the subject or subjects of the verb. Unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of an embodiment as described. In addition, the word “or” is considered to be the inclusive “or” rather than the exclusive or, and indicates at least one of, or any combination of items it conjoins.

Descriptions of embodiments of the invention in the present application are provided by way of example and are not intended to limit the scope of the invention. The described embodiments comprise different features, not all of which are required in all embodiments. Some embodiments utilize only some of the features or possible combinations of the features. Variations of embodiments of the invention that are described, and embodiments comprising different combinations of features noted in the described embodiments, will occur to a person having ordinary skill in the art. The scope of the invention is limited only by the claims.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A computer-implemented method of defining and using a data structure describing a virtual currency, the method comprising:
associating, by a controller, a fraction of a currency unit with at least one of: a history, an attribute, and a constraint; and
selecting, by a controller, a usage of the fraction, in a monetary transaction, based on the at least one of: the history, the attribute and the constraint.

2. The method of claim 1, comprising, selecting the fraction, for a transaction, based on the transaction and based on at least one of: the history, the attribute and the constraint.

3. The method of claim 1, comprising, selecting whether or not to accept the fraction in a transaction based on a constraint associated with a receiving account and based on at least one of: the history, the attribute and the constraint.

4. The method of claim 1, comprising:
associating the fraction with a secret function; and
calculating a value of the fraction based on the secret function and based the at least one of:
the history, the attribute and the constraint.

5. The method of claim 4, comprising, selecting to exchange a first fraction in a first account with a second fraction in a second account such that first and second values in the respective first and second accounts are increased.

6. The method of claim 4, wherein the exchange is performed by first and second computing devices over a direct network connection.

7. The method of claim 1, comprising modifying at least one of the history, the attribute and the constraint based on a transaction, and based on at least one of: the history, the attribute and the constraint.

8. The method of claim 1, wherein the history includes at least one of: a list of past owners of the fraction, a list of past sellers and buyers, a location, a date, a time of day, an amount, a coupon, a product purchased and a service purchased.

9. The method of claim 1, wherein the history is associated with at least two fragments of the currency.

10. The method of claim 1, comprising:
associating a set of fractions of the currency with a respective set of at least one of: a history, an attribute, and a constraint; and
selecting which of the fractions to use, in a transaction, based on relating at least one of: the a history, attribute and a constraint of the fractions to a constraint.

11. The method of claim 4, comprising, automatically performing the exchange based on locations of owners of the first and second accounts.

12. A computer-implemented method of defining and using a data structure describing a virtual currency, the method comprising:
associating, by a controller, a fraction of a currency with at least one of: a history, an attribute, and a constraint; and
selecting, by a controller, whether or not to accept the fraction in a transaction based on a constraint associated with a receiving account and based on at least one of: the history, the attribute and the constraint.

13. A system comprising:
a memory; and
one or more controllers configured to perform at least one of:
associating a fraction of a currency unit with at least one of: a history, an attribute, and a constraint; and
selecting a usage of the fraction, in a monetary transaction, based on the at least one of:
the history, the attribute and the constraint.

14. The system of claim 13, wherein the controller is configured to select the fraction, for a transaction, based on the transaction and based on at least one of: the history, the attribute and the constraint.

15. The system of claim 13, wherein the controller is configured to select whether or not to accept the fraction in a transaction based on a constraint associated with a receiving account and based on at least one of: the history, the attribute and the constraint.

16. The system of claim 13, wherein the controller is configured to:
associate the fraction with a secret function; and
calculate a value of the fraction based on the secret function and based the at least one of: the history, the attribute and the constraint.

17. The system of claim 16, wherein the controller is configured to select to exchange a first fraction in a first account with a second fraction in a second account such that first and second values in the respective first and second accounts are increased.

18. The system of claim 16, wherein the exchange is performed by first and second computing devices over a direct network connection.

19. The system of claim 13, wherein the controller is configured to modify at least one of the history, the attribute and the constraint based on a transaction, and based on at least one of: the history, the attribute and the constraint.

20. The system of claim 13, wherein the history includes at least one of: a list of past owners of the fraction, a list of past sellers and buyers, a location, a date, a time of day, an amount, a coupon, a product purchased and a service purchased.

21. The system of claim 13, wherein the controller is configured to:
associate a set of fractions of the currency with a respective set of at least one of: a history, an attribute, and a constraint; and
select first and second amounts of respective first and second fractions of the currency to use in a transaction, based on relating at least one of: the a history, attribute and a constraint of the fractions to a rule or preference.
